(19) United States
(12) Patent Application Publication
(10) Pub. No.: US 2023/0282902 A1
(43) Pub. Date: Sep. 7, 2023

(54) METHOD FOR MANUFACTURING BATTERY MODULE AND BATTERY MODULE

(71) Applicant: HONDA MOTOR CO., LTD., Tokyo (JP)

(72) Inventors: Yosuke YOSHIZAWA, Saitama (JP); Hidemasa USUI, Saitama (JP); Morinobu KAWAMURA, Saitama (JP)

(73) Assignee: HONDA MOTOR CO., LTD., Tokyo (JP)

(21) Appl. No.: 18/114,634

(22) Filed: Feb. 27, 2023

(30) Foreign Application Priority Data
Mar. 4, 2022 (JP) 2022-033324

(51) Int. Cl. H01M 10/653; H01M 50/289; H01M 50/124

(52) U.S. Cl. CPC H01M 10/653; H01M 50/124; H01M 50/289

(57) ABSTRACT

A method for manufacturing a battery module including a plurality of solid-state battery cells includes a cell arrangement step of arranging the plurality of solid-state battery cells in a manner of being not in contact with one another in a laminate direction, and restraining the plurality of solid-state battery cells by a restraining member including a fixing portion configured to fix each of the solid-state battery cells, a filling step of filling a space between the solid-state battery cells among the plurality of solid-state battery cells arranged in the laminate direction with a foamable material, and a foaming step of foaming the filled foamable material.

### CROSS-REFERENCE

This application is based on and claims priority under 35 USC 119 from Japanese Patent Application No. 2022-033324 filed on Mar. 4, 2022.

### TECHNICAL FIELD

The present disclosure relates to a method for manufacturing a battery module and the battery module.

### BACKGROUND ART

In recent years, as a specific measure against climatic variation of the earth, efforts to implement a low-carbon society or a decarbonized society have been actively made. Even in a moving object including a driving source such as a vehicle, a reduction in CO2 emission amount is strongly required, and the driving source is rapidly electrified. For example, as a vehicle, a vehicle including an electric motor serving as the driving source of the vehicle and a battery serving as a secondary battery which can supply electric power to the electric motor, such as an electrical vehicle or a hybrid electrical vehicle, has been developed. Generally, such a battery is formed by laminating a plurality of battery cells. Further, in recent years, a battery using a so-called all-solid-state battery as the battery cell (hereinafter, also referred to as a “solid-state battery cell”) has also been developed (for example, see JP-A-2020-173954).

The battery cell expands or contracts according to a usage condition (for example, a charging state). Particularly, the solid-state battery cell expands and contracts more significantly. When external dimensions of the battery module change due to such displacement of the solid-state battery cell, attachment to the vehicle becomes difficult. Therefore, it is considered that a cushion material which absorbs the displacement of the solid-state battery cell is disposed in the battery module. However, in the related art, there is a concern that a size of the battery module may be increased, and there is room for improvement from a viewpoint of appropriately restraining the solid-state battery cells while preventing a decrease in energy density of the battery module.

### SUMMARY

The present disclosure provides a technique capable of appropriately restraining solid-state battery cells while preventing an increase in a size of a battery module in the battery module including a plurality of solid-state battery cells.

According to a first aspect of the present disclosure, there is provided a method for manufacturing a battery module including a plurality of solid-state battery cells, the method including: a cell arrangement step of arranging the plurality of solid-state battery cells in a manner of being not in contact with one another in a laminate direction, and restraining the plurality of solid-state battery cells by a restraining member including a fixing portion configured to fix each of the solid-state battery cells, a filling step of filling a space between the solid-state battery cells among the plurality of solid-state battery cells arranged in the laminate direction with a foamable material; and a foaming step of foaming the filled foamable material.

According to a second aspect of the present disclosure, there is provided a method for manufacturing a battery module including a plurality of solid-state battery cells, the method including: a cell arrangement step of arranging the plurality of solid-state battery cells in a manner of being not in contact with one another in a laminate direction, and restraining the plurality of solid-state battery cells by a restraining member; a filling step of filling a space between the solid-state battery cells among the plurality of solid-state battery cells arranged in the laminate direction with a foamable material via a filling port provided in the restraining member; a foaming step of foaming the filled foamable material: and a sealing step of sealing the filling port after the filling step and before the foaming step is completed.

According to a third aspect of the present disclosure, there is provided a method for manufacturing a battery module including a plurality of solid-state battery cells, the method including: a cell arrangement step of arranging the plurality of solid-state battery cells in a manner of being not in contact with one another in a laminate direction, and restraining the plurality of solid-state battery cells by a restraining member; a foamable material filling step of filling a first region including a space between the solid-state battery cells among the plurality of solid-state battery cells arranged in the laminate direction with a foamable material; a potting material filling step of filling a second region adjacent to the first region with a potting material having thermal conductivity: a foaming step of foaming the foamable material which is filled: and a curing step of curing the potting material which is filled.

According to a fourth aspect of the present disclosure, there is provided a battery module including: a plurality of solid-state battery cells; a restraining member which includes a fixing portion configured to fix each of the solid-state battery cells, and which is configured to restrain the plurality of solid-state battery cells in a state where the plurality of solid-state battery cells are arranged in a manner of being not in contact with one another in a laminate direction; and an elastic member formed of a foamable material and filled between the solid-state battery cells among the plurality of solid-state battery cells arranged in the laminate direction.

According to a fifth aspect of the present disclosure, there is provided a battery module including: a plurality of solid-state battery cells; a restraining member configured to restrain the plurality of solid-state battery cells in a state where the plurality of solid-state battery cells are arranged in a manner of being not in contact with one another in a laminate direction; an elastic member formed of a foamable material and filled in a first region including a space between the solid-state battery cells among the plurality of solid-state battery cells arranged in the laminate direction; and a potting material filled in a second region adjacent to the first region and having thermal conductivity.

According to the present disclosure, in a battery module including a plurality of solid-state battery cells, it is possible to appropriately restrain the solid-state battery cells while preventing an increase in a size of the battery module.

### BRIEF DESCRIPTION OF DRAWINGS

FIG. 1 is a perspective view of a battery module 1 according to a first embodiment.

FIG. 2 is a view of the battery module 1 according to the first embodiment taken along a plane A-A illustrated in FIG. 1 and viewed from above.

FIG. 3 is a view of a binding bar 42 on an upper side of the battery module 1 according to the first embodiment when viewed from below.

FIG. 4 is a cross-sectional view of a solid-state battery cell 21 of the battery module 1 according to the first embodiment.

FIG. 5 is a flowchart illustrating an example of a method for manufacturing the battery module 1 according to the first embodiment.

FIG. 6 is a cross-sectional view of a battery module 10 according to a second embodiment.

FIG. 7 is a flowchart illustrating an example of a method for manufacturing the battery module 10 according to the second embodiment.

FIG. 8 is a diagram illustrating an example of separators 8 and a separator arrangement step.

### DESCRIPTION OF EMBODIMENTS

Hereinafter, embodiments of a method for manufacturing a battery module and the battery module according to the present disclosure will be described with reference to the drawings. It is assumed that the drawings are viewed in directions of reference signs. In the drawings, a front side of the battery module is denoted by Fr, a rear side of the battery module is denoted by Rr, a left side of the battery module is denoted by L, a right side of the battery module is denoted by R, an upper side of the battery module is denoted by U, and a lower side of the battery module is denoted by D. The front side, the rear side, the left side, the right side, the upper side, and the lower side of the battery module are irrelevant to, for example, a front side, a rear side, a left side, a right side, an upper side, and a lower side of a vehicle or the like on which the battery module is mounted.

### First Embodiment

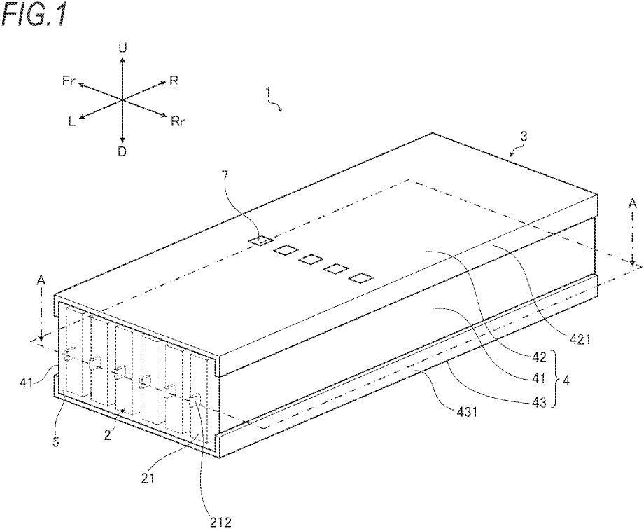

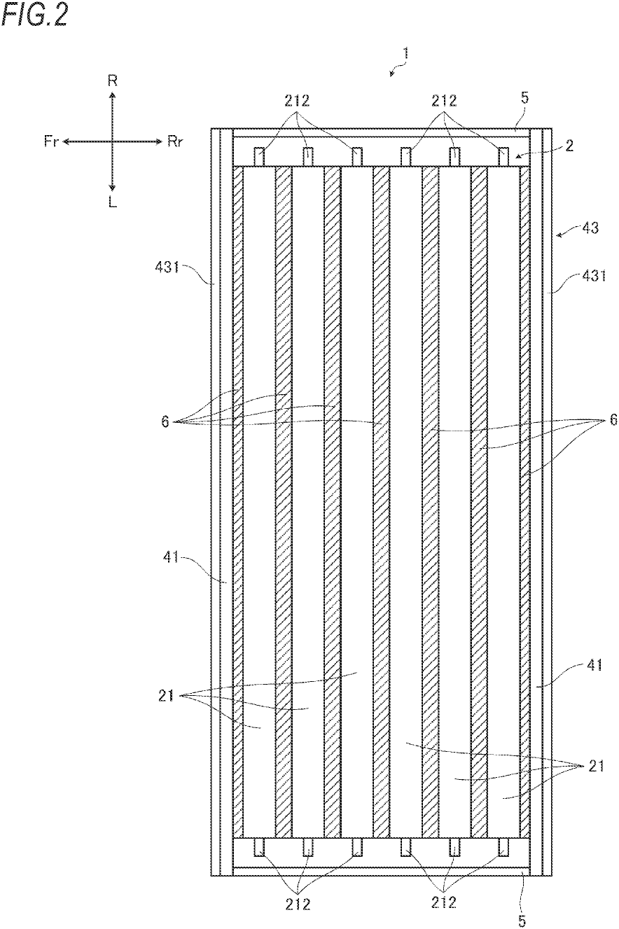

As illustrated in FIGS. 1 and 2, a battery module 1 according to a first embodiment includes a cell laminate 2 and a module case 3 which holds the cell laminate 2.

As illustrated in FIG. 2, the cell laminate 2 is formed by laminating a plurality of solid-state battery cells 21 in a front-rear direction. The solid-state battery cell 21 is a battery cell formed using an all-solid-state battery. Although illustration is omitted, the all-solid-state battery includes an all-solid-state battery positive electrode, an all-solid-state battery negative electrode, and a solid electrolyte disposed between the all-solid-state battery positive electrode and the all-solid-state battery negative electrode. In the all-solid-state battery, charging and discharging are performed by exchanging lithium ions between the all-solid-state battery positive electrode and the all-solid-state battery negative electrode via the solid electrolyte. The solid electrolyte is not particularly limited as long as the solid electrolyte has lithium ion conductivity and insulation properties, and a material generally used for the all-solid-state lithium ion battery can be used. For example, examples of the solid electrolyte can include a sulfide solid electrolyte material, an oxide solid electrolyte material, an inorganic solid electrolyte such as a lithium-containing salt, a polymer-based solid electrolyte such as polyethylene oxide, and a gel-based solid electrolyte containing the lithium-containing salt or a lithium-ion conductive ionic liquid. A form of the solid electrolyte material is not particularly limited, and examples thereof can include a particulate form.

An elastic member 6 is provided between the solid-state battery cells 21 of the cell laminate 2. The elastic member 6 is formed by foaming a foamable material filled in the module case 3. As the foamable material, for example, a polyurethane resin can be used. As an example, the elastic member 6 can be formed by foaming the polyurethane resin serving as the foamable material in a closed-cell structure. That is, the elastic member 6 may have the closed-cell structure.

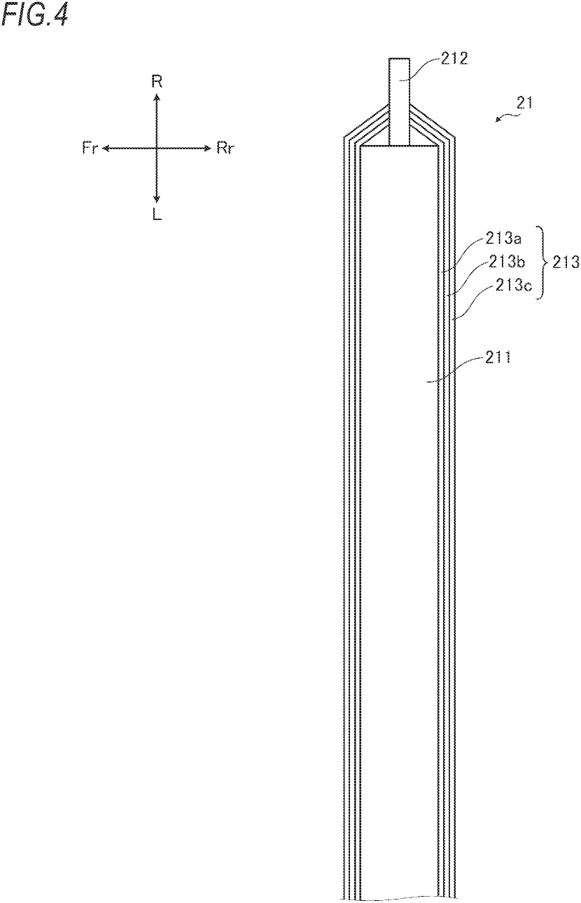

As illustrated in FIG. 4, the solid-state battery cell 21 includes an electricity storage body 211 implemented by the all-solid-state battery, current collection tabs 212 provided at both left and right ends (both ends in a longitudinal direction) of the electricity storage body 211, and an exterior member 213 which seals the electricity storage body 211. The exterior member 213 is a laminated film including an inner resin layer 213a in contact with the electricity storage body 211, a metal layer 213b which covers the inner resin layer 213a. and an outer resin layer 213c which covers the metal layer 213b.

As illustrated in FIG. 1, the module case 3 includes a restraining member 4 which restrains the solid-state battery cells 21 which constitute the cell laminate 2 in a state where the solid-state battery cells 21 are arranged in a manner of being not in contact with one another in a laminate direction, and a pair of side plates 5 which hold side surfaces of the cell laminate 2.

The restraining member 4 includes a pair of end plates 41 which hold a front surface and a rear surface of the cell laminate 2, and a pair of binding bars 42 and 43 which cover the cell laminate 2 from an upper-lower direction.

The pair of end plates 41 are disposed along the front surface and the rear surface of the cell laminate 2, and receive a load of the cell laminate 2 in the cell laminate direction. The load of the cell laminate 2 in the cell laminate direction may occur, for example, due to expansion of the solid-state battery cells 21 in addition to an external impact. The solid-state battery cell 21 expands according to a usage condition such as a charging state.

Binding portions 421 which protrude downward are provided at both front and rear end portions of the binding bar 42 on an upper side to restrain upper end portions of the pair of end plates 41 from a front-rear direction. Binding portions 431 which protrude upward are provided at both front and rear end portions of the binding bar 43 on a lower side to restrain lower end portions of the pair of end plates 41 from the front-rear direction.

The binding bar 42 on the upper side holds an upper surface of the cell laminate 2, and the binding bar 43 on the lower side holds a lower surface of the cell laminate 2. Both the binding bars 42 and 43 are formed using an aluminum alloy material or the like, and also function as heat dissipation members which transfer and dissipate heat of the cell laminate 2 by being in close contact with the upper surface and the lower surface of the cell laminate 2 respectively.

The battery module 1 includes the pair of side plates 5. The pair of side plates 5 are provided along a left side surface and a right side surface of the cell laminate 2, and hold the side surfaces of the cell laminate 2 by, for example, being coupled via the restraining member 4.

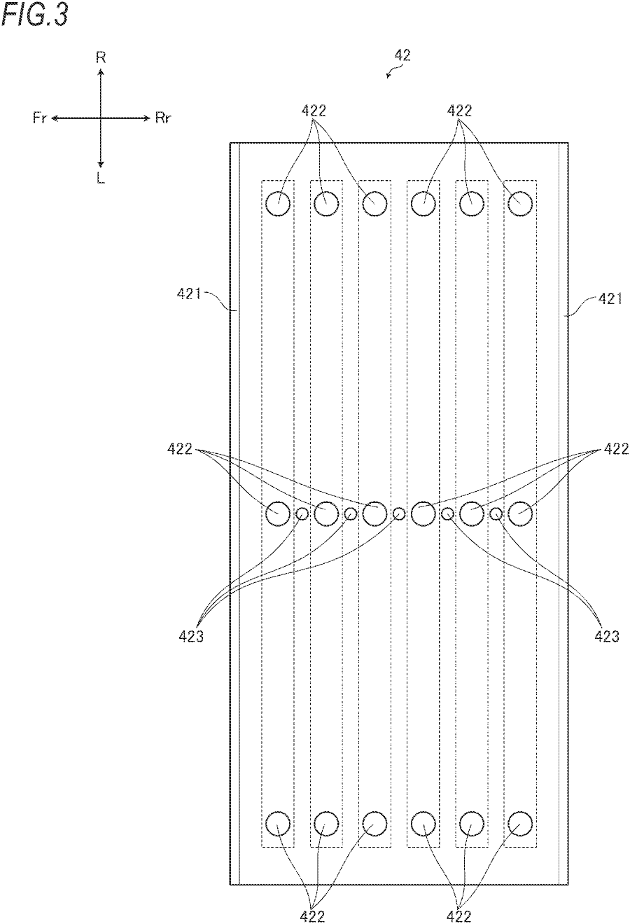

As illustrated in FIG. 3, the binding bar 42 on the upper side includes fixing portions 422 to which the solid-state battery cells 21 can be fixed. The fixing portions 422 are provided, for example, at central portions in a left-right direction and both left and right end portions of fixing positions of the solid-state battery cells 21 with respect to the binding bar 42. Each solid-state battery cell 21 is fixed to the binding bar 42 on the upper side by, for example, an adhesive applied to the fixing portion 422. Further, for example, the fixing portion 422 is marked, and is also used for positioning the solid-state battery cell 21.

The fixing portion 422 is not limited to the example described above. For example, the fixing portion 422 may be provided only at the central portion in the left-right direction of the fixing position of each solid-state battery cell 21 with respect to the binding bar 42. Further, the fixing portion 422 may be provided in a manner of sandwiching the solid-state battery cell 21 from the front-rear direction. In this case, the fixing portion 422 is provided based on, for example, maximum expansion of the solid-state battery cell 21 (for example, when SOC of the solid-state battery cell 21 is 100%). Accordingly, even if the solid-state battery cell 21 expands, the fixing portion 422 can be prevented from being damaged. Further, the fixing portion 422 may be formed by applying a potting material or the like onto the binding bar 42. Furthermore, the battery module 1 may be formed by covering the cell laminate 2 with the laminated film instead of using the module case 3 described above. In this case, the fixing portion 422 may be implemented by a fold or the like of the laminated film.

A plurality of filling ports 423 for filling the foamable material are provided in the binding bar 42 on the upper side. The filling port 423 is provided at a position corresponding to a gap between the solid-state battery cells 21. In the present embodiment, the filling ports 423 are provided alternately with the fixing portions 422 at the central portion in the left-right direction of the binding bar 42 on the upper side. Although details will be described later, after a foaming material which becomes the elastic member 6 is filled in the gap between the solid-state battery cells 21, the filling port 423 is sealed by a sealing member 7 as illustrated in FIG. 1. As the sealing member 7, for example, a bonding seal which can hermetically seal the filling port 423 by being bonded to an upper surface (surface) of the binding bar 42 on the upper side can be used.

The binding bar 43 on the lower side is obtained by removing the filling ports 423 from the binding bar 42 on the upper side. That is, similar to the binding bar 42 on the upper side, the binding bar 43 on the lower side includes fixing portions (not illustrated) to which the solid-state battery cells 21 can be fixed. The solid-state battery cells 21 are fixed to the binding bar 43 on the lower side by, for example, an adhesive applied to the fixing portions.

According to the battery module 1 of the first embodiment configured as described above, the elastic member 6 formed of the foamable material can be provided between the solid-state battery cells 21. Accordingly, as compared with a case where a cushion material molded in advance is used as the elastic member between the solid-state battery cells 21, a gap in which no elastic member is provided can be reduced. Therefore, a volume of the elastic member 6 can be increased by efficiently using a space between the solid-state battery cells 21. and a restoring force of the elastic member 6 can be improved. Therefore, it is possible to appropriately restrain each solid-state battery cell 21 for which a high load restraint is required while preventing an increase in a size of the battery module 1.

According to the battery module 1 of the first embodiment, since the elastic member 6 between the solid-state battery cells 21 is formed of the foamable material, as compared with the case where the elastic member 6 is formed of the cushion material molded in advance, it is possible to reduce the gap not in contact with the elastic member 6 of a surface of the laminated film which is the exterior member 213 of the solid-state battery cell 21.

According to the battery module 1 of the first embodiment, since the elastic member 6 has the closed-cell structure, the restoring force of the elastic member 6 can be improved.

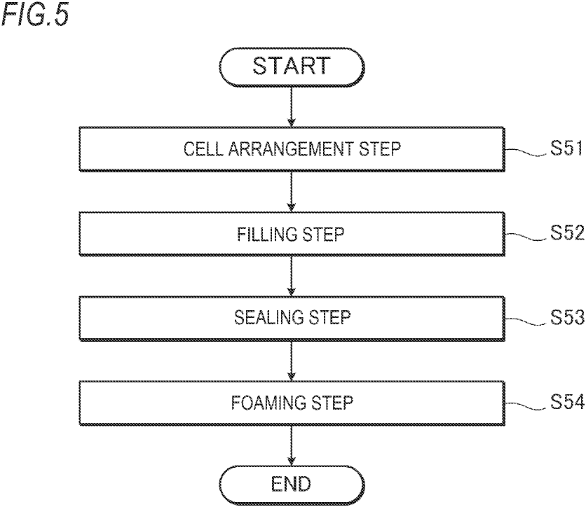

Next, a method for manufacturing the battery module 1 according to the first embodiment will be described with reference to FIG. 5.

As illustrated in FIG. 5, in the method for manufacturing the battery module 1 according to the first embodiment, first, a cell arrangement step is performed (step S51). The cell arrangement step is a step of arranging the plurality of solid-state battery cells 21 in a manner of being not in contact with one another in the laminate direction, and restraining the plurality of solid-state battery cells 21 by the restraining member 4. The cell arrangement step includes, for example, a step of adhering and fixing the solid-state battery cells 21 to the binding bars 42 and 43 respectively on the upper side and the lower side.

Next, a filling step is performed (step S52). The filling step is a step of filling the gaps among the solid-state battery cells 21 with the foamable materials via the filling ports 423 of the binding bar 42 on the upper side. Further, in the filling step, spaces between the solid-state battery cells 21 and the end plates 41 disposed at both ends in the front-rear direction may also be filled with the foamable materials.

Next, a sealing step is performed (step S53). The sealing step is a step of sealing the filling port 423 by the sealing member 7 or the like.

Next, a foaming step is performed (step S54). The foaming step is a step of foaming the foamable materials filled in the filling step described above by heating the foamable materials. As described above, at this time, the foamable material may be foamed in a manner of having the closed-cell structure.

Through a series of steps illustrated in FIG. 5, the battery module 1 in which the elastic member 6 formed of the foamable material is provided between the solid-state battery cells 21 is completed. In the example described here, the sealing step is performed before the foaming step, but the present disclosure is not limited thereto. The sealing step may be performed after the filling step and before the foaming step is completed, and may be performed, for example, at any timing after the foaming step is started and before the foaming step is completed.

According to the method for manufacturing the battery module 1 of the first embodiment described above, the elastic member 6 formed of the foamable material can be provided between the solid-state battery cells 21. Accordingly, as compared with the case where the cushion material molded in advance is used as the elastic member between the solid-state battery cells 21. the gap in which no elastic member is provided can be reduced. Therefore, the volume of the elastic member 6 can be increased by efficiently using the space between the solid-state battery cells 21, and the restoring force of the elastic member 6 can be improved. Therefore, it is possible to appropriately restrain each solid-state battery cell 21 for which a high load restraint is required while preventing the increase in the size of the battery module 1.

According to the method for manufacturing the battery module 1 of the first embodiment, by sealing the filling ports 423 in the sealing step after the filling step and before the foaming step is completed, a gas (for example, CO2) generated by foaming the foamable material can be retained in the battery module 1, and the solid-state battery cells 21 can be restrained by also using a pressure caused by the gas.

### Second Embodiment

Next, a second embodiment of the present disclosure will be described. Most of the configuration of the battery module 1 according to the first embodiment is common to a configuration of a battery module 10 according to the second embodiment. In the following description, components common to those in the first embodiment are denoted by the same reference signs, and description thereof will be appropriately omitted.

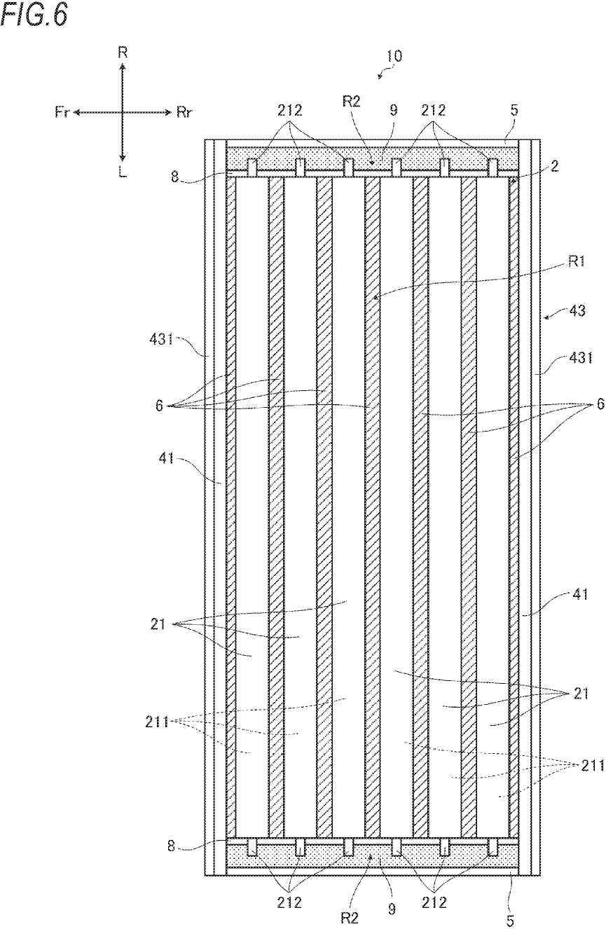

As illustrated in FIG. 6, in the battery module 10 according to the second embodiment, separators 8 are provided in the module case 3. An inside of the module case 3 is partitioned by the separators 8 into a first region R1 including spaces among the solid-state battery cells 21 of the cell laminate 2 and a second region R2 adjacent to the first region R1. The current collection tabs 212 are present in the second region R2.

The elastic members 6 are provided in the first region R1. and a potting material 9 having thermal conductivity is provided in the second region R2. The elastic member 6 is obtained by foaming a foamable material filled in the first region R1. The potting material 9 is obtained by curing a resin filled in the second region R2.

According to the battery module 10 of the second embodiment configured as described above, the elastic members 6 formed of the foamable materials can be provided in the first region R1 including the spaces among the solid-state battery cells 21. Accordingly, as compared with a case where a cushion material molded in advance is used as the elastic member between the solid-state battery cells 21, a gap in which no elastic member is provided can be reduced. Therefore, a volume of the elastic member 6 can be increased by efficiently using a space between the solid-state battery cells 21, and a restoring force of the elastic member 6 can be improved. Therefore, it is possible to appropriately restrain each solid-state battery cell 21 for which a high load restraint is required while preventing an increase in a size of the battery module 10.

According to the battery module 10 of the second embodiment, by providing the potting material 9 in the second region R2 adjacent to the first region R1. the elastic member 6 which tends to spread as the solid-state battery cell 21 expands can be suppressed by a reaction force of the potting material 9, and each solid-state battery cell 21 can be restrained by also using the reaction force. Further, the separators 8 are provided in the module case 3. so that the first region R1 can be easily filled with the foamable material.

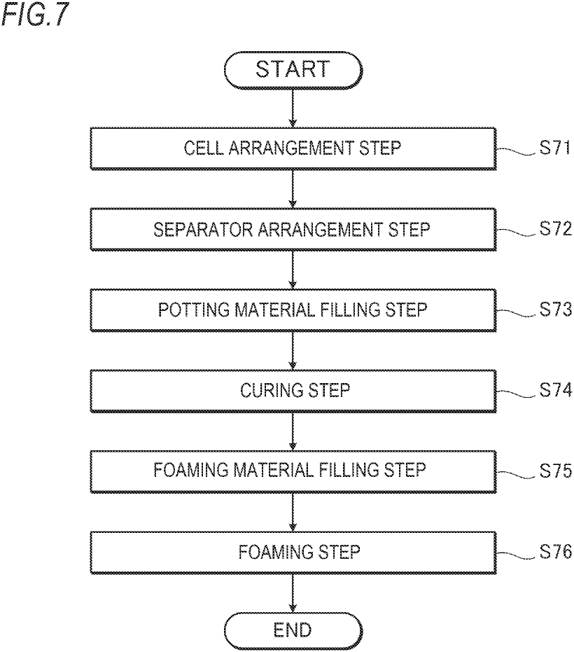

Next, a method for manufacturing the battery module 10 according to the second embodiment will be described with reference to FIG. 7.

As illustrated in FIG. 7, in the method for manufacturing the battery module 10 according to the second embodiment, first, a cell arrangement step is performed (step S71). Similar to the cell arrangement step in step S51, the cell arrangement step in step S71 is a step of arranging the plurality of solid-state battery cells 21 in a manner of being not in contact with one another in a laminate direction, and restraining the plurality of solid-state battery cells 21 by the restraining member 4.

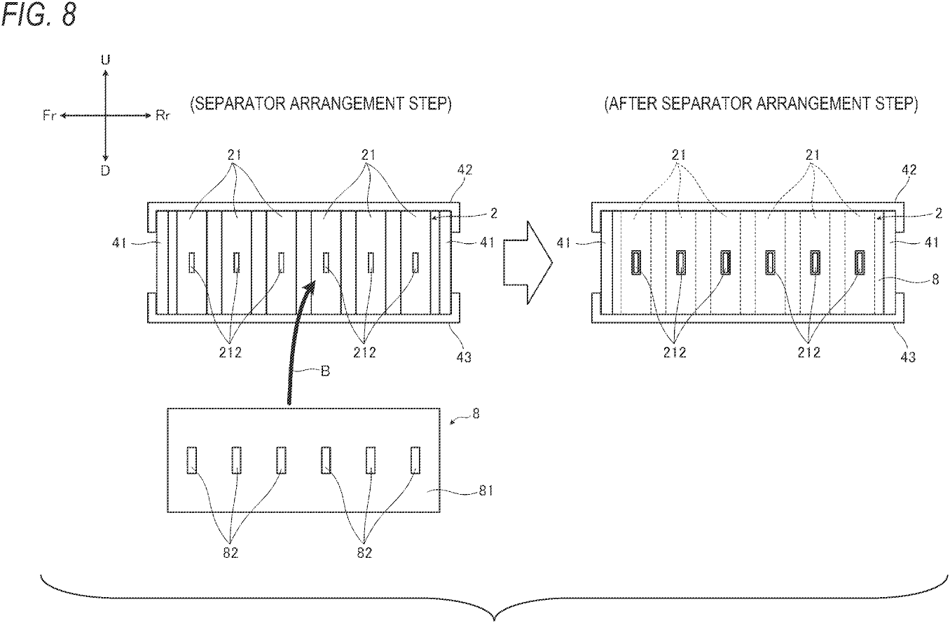

Next, a separator arrangement step is performed (step S72). The separator arrangement step is a step of disposing the separators 8 in the module case 3. Specifically, as illustrated in FIG. 8, the separator 8 is formed by providing openings 82 in a rectangular separator main body 81. When the separator 8 is disposed in the module case 3, the opening 82 is provided at a position corresponding to the current collection tab 212 of each solid-state battery cell 21 disposed in the module case 3. Accordingly, the separator 8 can cause the current collection tabs 212 of the solid-state battery cells 21 to protrude toward a second region R2 side via the openings 82. The separator 8 may be formed of metal, or may be formed of a resin, rubber, or the like.

In the separator arrangement step, a pair of separators 8 are disposed on a left side and a right side of the cell laminate 2 (see an arrow of a reference sign B in FIG. 8) in a manner of sandwiching the cell laminate 2 (solid-state battery cells 21) fixed to the binding bars 42 and 43 respectively on the upper side and the lower side from a left-right direction. In the separator arrangement step, the separators 8 are disposed in a manner of partitioning the first region R1 and the second region R2 in the module case 3. Further, as illustrated in FIG. 6, the separator 8 is provided on an outer side in a left-right direction with respect to the electricity storage bodies 211 of the solid-state battery cells 21. Therefore, it is possible to prevent the separators 8 from hindering expansion of the electricity storage bodies 211 of the solid-state battery cells 21 in the laminate direction.

Next, a potting material filling step is performed (step S73). The potting material filling step is a step of filling the second region R2 with a resin which is the potting material 9. For example, a filling port (not illustrated) for filling the second region R2 with the resin which is the potting material 9 is provided at a position corresponding to the second region R2 in the binding bar 42 on the upper side. In the potting material filling step, the second region R2 is filled with the resin which is the potting material 9 via the filling port of the binding bar 42 on the upper side. Further, in the potting material filling step, the second region R2 may be filled with the resin which is the potting material 9 by using the filling ports 423 described above.

Next, a curing step is performed (step S74). The curing step is a step of curing the resin filled in the second region R2. Accordingly, the potting material 9 is formed in the second region R2.

Next, a foaming material filling step is performed (step S75). The foaming material filling step is a step of filling the first region R1 including the gaps among the solid-state battery cells 21 with the foamable material via the filling ports 423 of the binding bar 42 on the upper side. Further, in the foaming material filling step, the spaces between the solid-state battery cells 21 and the end plates 41 disposed at both ends in a front-rear direction may also be filled with the foamable materials.

Next, a foaming step is performed (step S76). The foaming step is a step of foaming the foamable material filled in the foaming material filling step described above by heating or the like. As described above, at this time, the foamable material may be foamed in a manner of having the closed-cell structure. Further, as in the first embodiment, a sealing step of sealing the filling ports 423 may be performed after the foaming material filling step and before the foaming step is completed.

Through the series of steps illustrated in FIG. 7, the battery module 10 in which the elastic members 6 formed of the foamable materials are provided in the first region R1 and the potting material 9 having the thermal conductivity is provided in the second region R2 is completed. In the example described here, the curing step is performed before the foaming material filling step, but the present invention is not limited thereto. The foaming material filling step may be performed after the potting material filling step, and for example, the foaming material filling step may be performed after the potting material filling step, and then the curing step and the foaming step may be performed substantially at the same time. In this way, as compared with a case where the curing step and the foaming step are performed at different times, a time required for manufacturing the battery module 10 can be shortened.

According to the method for manufacturing the battery module 10 of the second embodiment described above, the elastic members 6 formed of the foamable materials can be provided in the first region R1 including the spaces among the solid-state battery cells 21. Accordingly, as compared with the case where the cushion material molded in advance is used as the elastic member between the solid-state battery cells 21, the gap in which no elastic member is provided can be reduced. Therefore, the volume of the elastic member 6 can be increased by efficiently using the space between the solid-state battery cells 21, and the restoring force of the elastic member 6 can be improved. Therefore, it is possible to appropriately restrain each solid-state battery cell 21 for which the high load restraint is required while preventing the increase in the size of the battery module 10.

According to the method for manufacturing the battery module 10 of the second embodiment, by providing the potting material 9 in the second region R2 adjacent to the first region R1, the elastic member 6 which tends to spread as the solid-state battery cell 21 expands can be suppressed by the reaction force of the potting material 9, and each solid-state battery cell 21 can be restrained by also using the reaction force.

According to the method for manufacturing the battery module 10 of the second embodiment, the separators 8 which partition the first region R1 and the second region R2 can be provided by performing the separator arrangement step before the potting material filling step and the foamable material filling step, and the second region R2 can be easily filled with the resin (potting material 9) in the potting material filling step and the first region R1 can be easily filled with the foamable material in the foamable material filling step.

According to the method for manufacturing the battery module 10 of the second embodiment, since the foamable material filling step is performed after the potting material filling step, the reaction force from the potting material 9 via the separators 8 can suppress expansion of the foamable material filled in the first region R1 toward the second region R2 side due to the foaming.

Although the embodiments of the present invention have been described above with reference to the accompanying drawings, it is needless to say that the present invention is not limited to the embodiments. It will be apparent to those skilled in the art that various changes and modifications may be conceived within the scope of the claims. It is also understood that the various changes and modifications belong to the technical scope of the present invention. Further, the components in the embodiments described above may be combined freely within a range not departing from the spirit of the invention.

For example, in the embodiments described above, the elastic member 6 is provided not only in the gap between the solid-state battery cells 21 of the cell laminate 2. but also between the solid-state battery cell 21 and the end plate 41 disposed at both ends in the front-rear direction, but the elastic member 6 between the solid-state battery cell 21 and the end plate 41 may be omitted.

In the embodiments described above, the filling ports 423 are provided in the binding bar 42 on the upper side, but no filling port 423 may be provided, and the gap between the solid-state battery cells 21 may be filled with the foamable material before the binding bar 42 on the upper side is attached to the binding bar 43 on the lower side. In this case, the sealing step (step S54) of sealing the filling ports 423 is unnecessary.

In the embodiments described above, the exterior member 213 of the solid-state battery cell 21 includes the outer resin layer 213c which covers the metal layer 213b, but when the potting material 9 is provided in the second region R2 as in the second embodiment, since the elastic member 6 and the potting material 9 can have an insulation function and chemical resistance of the solid-state battery cell 21. the outer resin layer 213c can be omitted. The outer resin layer 213c is omitted, so that heat dissipation performance of the solid-state battery cell 21 can be improved. Further, by omitting the outer resin layer 213c. a size of the solid-state battery cell 21 can be decreased (for example, a thickness in the laminate direction can be decreased) while maintaining a size of the electricity storage body 211, and therefore it is also possible to contribute to improvement in energy density.

In the embodiments described above, the battery module 10 includes the separators 8, but the present invention is not limited thereto. For example, after the separator arrangement step (step S72) to the curing step (step S74) are performed, a separator removal step of removing the separators 8 disposed in the separator arrangement step from an inside of the module case 3 may be performed, and after the separator removal step, the foamable material filling step (step S75) and the foaming step (step S76) may be performed. Accordingly, the battery module 10 in which the elastic members 6 are provided in the first region R1, the potting material 9 is provided in the second region R2. and no separator 8 is provided can be formed.

In the present specification, at least the following matters are described. Corresponding components and the like in the embodiments described above are shown in parentheses as examples, but the present invention is not limited thereto.

(1) A method for manufacturing a battery module (the battery module 1) including a plurality of solid-state battery cells (the solid-state battery cells 21), the method including:
a cell arrangement step (steps S51 and S71) of arranging the plurality of solid-state battery cells in a manner of being not in contact with one another in a laminate direction, and restraining the plurality of solid-state battery cells by a restraining member (the restraining member 4) including a fixing portion (the fixing portion 422) configured to fix each of the solid-state battery cells:
a filling step (steps S52 and S73) of filling a space between the solid-state battery cells among the plurality of solid-state battery cells arranged in the laminate direction with a foamable material; and
a foaming step (steps S54 and S74) of foaming the filled foamable material.

According to (1), an elastic member formed of the foamable material can be provided between the solid-state battery cells. Accordingly, as compared with a case where a cushion material molded in advance is used as the elastic member between the solid-state battery cells, a gap in which no elastic member is provided can be reduced. Therefore, a volume of the elastic member can be increased by efficiently using the space between the solid-state battery cells, and a restoring force of the elastic member can be improved. Therefore, it is possible to appropriately restrain each of the solid-state battery cells for which a high load restraint is required while preventing an increase in a size of the battery module.

(2) A method for manufacturing a battery module (the battery module 1) including a plurality of solid-state battery cells (the solid-state battery cells 21), the method including:
a cell arrangement step (step S51) of arranging the plurality of solid-state battery cells in a manner of being not in contact with one another in a laminate direction, and restraining the plurality of solid-state battery cells by a restraining member;
a filling step (step S52) of filling a space between the solid-state battery cells among the plurality of solid-state battery cells arranged in the laminate direction with a foamable material via a filling port (the filling port 423) provided in the restraining member:
a foaming step (step S54) of foaming the filled foamable material; and
a sealing step (step S53) of sealing the filling port after the filling step and before the foaming step is completed.

According to (2), an elastic member formed of the foamable material can be provided between the solid-state battery cells. Accordingly, as compared with a case where a cushion material molded in advance is used as the elastic member between the solid-state battery cells, a gap in which no elastic member is provided can be reduced. Therefore, a volume of the elastic member can be increased by efficiently using the space between the solid-state battery cells, and a restoring force of the elastic member can be improved. Therefore, it is possible to appropriately restrain each solid-state battery cell for which a high load restraint is required while preventing an increase in a size of the battery module. Further, according to (2), by sealing the filling port in the sealing step after the filling step and before the foaming step is completed, a gas generated by foaming the foamable material can be retained in the battery module, and the solid-state battery cells can be restrained by also using a pressure caused by the gas.

(3) A method for manufacturing a battery module (the battery module 10) including a plurality of solid-state battery cells (the solid-state battery cells 21), the method including:
a cell arrangement step (step S71) of arranging the plurality of solid-state battery cells in a manner of being not in contact with one another in a laminate direction, and restraining the plurality of solid-state battery cells by a restraining member;
a foamable material filling step (step S73) of filling a first region (the first region R1) including a space between the solid-state battery cells among the plurality of solid-state battery cells arranged in the laminate direction with a foamable material;
a potting material filling step (step S75) of filling a second region (the second region R2) adjacent to the first region with a potting material (the potting material 9) having thermal conductivity;
a foaming step (step S74) of foaming the foamable material which is filled: and
a curing step (step S76) of curing the potting material which is filled.

According to (3), an elastic member formed of the foamable material can be provided in the first region including the space between the solid-state battery cells. Accordingly, as compared with a case where a cushion material molded in advance is used as the elastic member between the solid-state battery cells, a gap in which no elastic member is provided can be reduced. Therefore, a volume of the elastic member can be increased by efficiently using the space between the solid-state battery cells, and a restoring force of the elastic member can be improved. Therefore, it is possible to appropriately restrain each solid-state battery cell for which a high load restraint is required while preventing an increase in a size of the battery module. Further, according to (3), by providing the potting material in the second region adjacent to the first region, the elastic member which tends to spread as the solid-state battery cell expands can be suppressed by a reaction force of the potting material, and each solid-state battery cell can be restrained by also using the reaction force.

(4) The method for manufacturing the battery module according to (3), further including:
a separator arrangement step (step S72) of disposing a separator (the separator 8) configured to partition the first region and the second region before the foamable material filling step and the potting material filling step.

According to (4), since the separator which partitions the first region and the second region can be provided before the first region is filled with the foamable material and the second region is filled with the potting material, the first region can be easily filled with the foamable material and the second region can be easily filled with the potting material.

(5) The method for manufacturing the battery module according to (3) or (4),
in which the foamable material filling step is performed after the potting material filling step.

According to (5), since the foamable material filling step is performed after the potting material filling step, a reaction force from the potting material filled in the second region can suppress expansion of the foamable material filled in the first region in the foamable material filling step toward a second region side due to the foaming_{.}

(6) A battery module (the battery module 1 or 10) including:
a plurality of solid-state battery cells (the solid-state battery cells 21);
a restraining member (the restraining member 4) which includes a fixing portion configured to fix each of the solid-state battery cells, and which is configured to restrain the plurality of solid-state battery cells in a state where the plurality of solid-state battery cells are arranged in a manner of being not in contact with one another in a laminate direction; and
an elastic member (the elastic member 6) formed of a foamable material and filled between the solid-state battery cells among the plurality of solid-state battery cells arranged in the laminate direction.

According to (6), an elastic member formed of the foamable material can be provided between the solid-state battery cells. Accordingly, as compared with a case where a cushion material molded in advance is used as the elastic member between the solid-state battery cells, a gap in which no elastic member is provided can be reduced. Therefore, a volume of the elastic member can be increased by efficiently using the space between the solid-state battery cells, and a restoring force of the elastic member can be improved. Therefore, it is possible to appropriately restrain each solid-state battery cell for which a high load restraint is required while preventing an increase in a size of the battery module.

(7) A battery module (the battery module 10) including:
a plurality of solid-state battery cells (the solid-state battery cells 21);
a restraining member (the restraining member 4) configured to restrain the plurality of solid-state battery cells in a state where the plurality of solid-state battery cells are arranged in a manner of being not in contact with one another in a laminate direction:
an elastic member (the elastic member 6) formed of a foamable material and filled in a first region (the first region R1) including a space between the solid-state battery cells among the plurality of solid-state battery cells arranged in the laminate direction; and
a potting material (the potting material 9) filled in a second region (the second region R2) adjacent to the first region and having thermal conductivity.

According to (7), the elastic member formed of the foamable material can be provided in the first region including the space between the solid-state battery cells. Accordingly, as compared with a case where a cushion material molded in advance is used as the elastic member between the solid-state battery cells, a gap in which no elastic member is provided can be reduced. Therefore, a volume of the elastic member can be increased by efficiently using the space between the solid-state battery cells, and a restoring force of the elastic member can be improved. Therefore, it is possible to appropriately restrain each solid-state battery cell for which a high load restraint is required while preventing an increase in a size of the battery module. Further, according to (7), by providing the potting material in the second region adjacent to the first region, the elastic member which tends to spread as the solid-state battery cell expands can be suppressed by a reaction force of the potting material, and each solid-state battery cell can be restrained by also using the reaction force.

(8) The battery module according to (7), further including:
a separator (the separator 8) configured to partition the first region and the second region.

According to (8), since the separator which partitions the first region and the second region is provided, the first region can be easily filled with the foamable material.

(9) The battery module according to (7) or (8),
in which the solid-state battery cell includes a laminated film serving as an exterior member (the exterior member 213), and
in which the laminated film is formed by an inner resin layer in contact with an electricity storage body of the solid-state battery cell and a metal layer configured to cover the inner resin layer.

According to (9), the laminated film serving as the exterior member of the solid-state battery cell is formed by the inner resin layer in contact with the electricity storage body of the solid-state battery cell and the metal layer which covers the inner resin layer, and therefore heat dissipation performance of the solid-state battery cell can be improved.

(10) The battery module according to any one of (6) to (9),
in which the elastic member has a closed-cell structure.

According to (10), since the elastic member has the closed-cell structure, a restoring force of the elastic member can be improved.

What is claimed is:

1. A method for manufacturing a battery module including a plurality of solid-state battery cells, the method comprising:
a cell arrangement step of arranging the plurality of solid-state battery cells in a manner of being not in contact with one another in a laminate direction, and restraining the plurality of solid-state battery cells by a restraining member including a fixing portion configured to fix each of the solid-state battery cells;
a filling step of filling a space between the solid-state battery cells among the plurality of solid-state battery cells arranged in the laminate direction with a foamable material; and
a foaming step of foaming the filled foamable material.

2. A method for manufacturing a battery module including a plurality of solid-state battery cells, the method comprising:
a cell arrangement step of arranging the plurality of solid-state battery cells in a manner of being not in contact with one another in a laminate direction, and restraining the plurality of solid-state battery cells by a restraining member;
a filling step of filling a space between the solid-state battery cells among the plurality of solid-state battery cells arranged in the laminate direction with a foamable material via a filling port provided in the restraining member;
a foaming step of foaming the filled foamable material; and
a sealing step of sealing the filling port after the filling step and before the foaming step is completed.

3. A method for manufacturing a battery module including a plurality of solid-state battery cells, the method comprising:
a cell arrangement step of arranging the plurality of solid-state battery cells in a manner of being not in contact with one another in a laminate direction, and restraining the plurality of solid-state battery cells by a restraining member;
a foamable material filling step of filling a first region including a space between the solid-state battery cells among the plurality of solid-state battery cells arranged in the laminate direction with a foamable material;
a potting material filling step of filling a second region adjacent to the first region with a potting material having thermal conductivity;
a foaming step of foaming the foamable material which is filled; and
a curing step of curing the potting material which is filled.

4. The method for manufacturing the battery module according to claim 3, further comprising:
a separator arrangement step of disposing a separator configured to partition the first region and the second region before the foamable material filling step and the potting material filling step.

5. The method for manufacturing the battery module according to claim 3,
wherein the foamable material filling step is performed after the potting material filling step.

6. A battery module comprising:
a plurality of solid-state battery cells;
a restraining member which includes a fixing portion configured to fix each of the solid-state battery cells, and which is configured to restrain the plurality of solid-state battery cells in a state where the plurality of solid-state battery cells are arranged in a manner of being not in contact with one another in a laminate direction; and
an elastic member formed of a foamable material and filled between the solid-state battery cells among the plurality of solid-state battery cells arranged in the laminate direction.

7. A battery module comprising:
a plurality of solid-state battery cells;
a restraining member configured to restrain the plurality of solid-state battery cells in a state where the plurality of solid-state battery cells are arranged in a manner of being not in contact with one another in a laminate direction;
an elastic member formed of a foamable material and filled in a first region including a space between the solid-state battery cells among the plurality of solid-state battery cells arranged in the laminate direction; and
a potting material filled in a second region adjacent to the first region and having thermal conductivity.

8. The battery module according to claim 7, further comprising:
a separator configured to partition the first region and the second region.

9. The battery module according to claim 7,
wherein the solid-state battery cell includes a laminated film serving as an exterior member, and
wherein the laminated film is formed by an inner resin layer in contact with an electricity storage body of the solid-state battery cell and a metal layer configured to cover the inner resin layer.

10. The battery module according to claim 6,
wherein the elastic member has a closed-cell structure.
